(19) United States
(12) Patent Application Publication
(10) Pub. No.: US 2026/0339248 A1
(43) Pub. Date: Oct. 29, 2026

(54) FUSER DEVICE AND IMAGE FORMING APPARATUS

(71) Applicant: CANON KABUSHIKI KAISHA, Tokyo (JP)

(72) Inventors: SUGURU TAKEUCHI, Chiba (JP); YASUHARU TORATANI, Chiba (JP); HIROSHI MIYAMOTO, Saitama (JP); KIYONORI SOTOME, Ibaraki (JP); MASAKI SUDA, Chiba (JP); RIKIYA TAKEMASA, Chiba (JP)

(21) Appl. No.: 19/558,700

(22) Filed: Mar. 6, 2026

(30) Foreign Application Priority Data
Apr. 25, 2025 (JP) 2025-073135

(51) Int. Cl. G03G 15/20

(52) U.S. Cl. CPC G03G 15/2057; G03G 15/2064; G03G 2215/2035

(57) ABSTRACT

There is provided a fuser device including: a rotatable endless belt; a heating member configured to be located inside the belt, to tension the belt, and to heat the belt; a rotatable pressure member configured to abut the belt to nip and convey, together with the belt, a recording medium; a nip formation member configured to face the pressure member via the belt and to abut the belt to form a fuser nip portion; and a support member configured to support the nip formation member. The support member includes a first heat absorption portion having a total emissivity of 40% or more on a surface facing an inner circumferential surface of the belt.

### BACKGROUND

### Field of the Technology

The present disclosure relates to a fuser device that fixes, to a recording medium, a toner image on the recording medium, and an image forming apparatus including the fuser device.

### Description of the Related Art

In image forming apparatuses such as electrophotographic apparatuses or electrostatic recording apparatuses, an unfixed toner image is formed on a sheet-shaped recording medium, and the unfixed toner image formed on the recording medium is fixed on the recording medium by being heated and pressed by a fuser device. As the fuser device, a so-called belt fuser device using a fuser belt and a pressure roller is known.

In the belt fuser device, an outer circumferential surface of the pressure roller and an outer circumferential surface of the fuser belt are located in contact with each other to rotate the fuser belt driven by rotation of the pressure roller, and the fuser belt and the pressure roller are brought into contact with each other to form a fuser nip portion. In addition, a heating roller is located in contact with the fuser belt, on an inner side of the fuser belt. In such a belt fuser device, a heating roller heated by a heat source supplies heat to the fuser belt, and a recording medium carrying an unfixed toner image is nipped and conveyed in the fuser nip portion, whereby the toner image is fixed to the recording medium by heat and pressure.

Japanese Patent Application Laid-Open No. 2020-154266 discloses a belt fuser device in which a heating source is provided not only inside a heating roller but also inside a nip formation member that faces a pressure roller via a fuser belt to form a fuser nip portion. The nip formation member needs to be increased in stiffness since a large load is applied thereto, thus having a large heat capacity since a thickness of the member is thick. The belt fuser device of Japanese Patent Application Laid-Open No. 2020-154266 reflects a demand for rapidly warming up the nip formation member to a target temperature, by providing a heating source inside the nip formation member.

However, in Japanese Patent Application Laid-Open No. 2020-154266, faster warm-up operation needs to be performed in order to further improve user convenience.

### SUMMARY

A fuser device according to the present disclosure is a fuser device configured to fix, to a recording medium, a toner image on the recording medium, the fuser device including: a rotatable endless belt; a heating member configured to be located inside the belt, to tension the belt, and to heat the belt; a rotatable pressure member configured to abut the belt to nip and convey, together with the belt, a recording medium; a nip formation member configured to face the pressure member via the belt and to abut the belt to form a fuser nip portion; and a support member configured to support the nip formation member. The support member includes a first heat absorption portion having a total emissivity of 40% or more on a surface facing an inner circumferential surface of the belt.

Further features of the present disclosure will become apparent from the following description of exemplary embodiments with reference to the attached drawings.

### BRIEF DESCRIPTION OF THE DRAWINGS

FIG. 1 is a schematic diagram of an image forming apparatus according to Embodiment 1 of the present disclosure.

FIG. 2 is a schematic diagram of a fuser device according to Embodiment 1 of the present disclosure.

FIGS. 3(a), 3(b), and 3(c) are schematic diagrams illustrating, together with a comparative example, a stay of the fuser device according to Embodiment 1 of the present disclosure.

FIGS. 4(a) and 4(b) are graphs illustrating, together with a comparative example, a temperature change of the fuser device according to Embodiment 1 of the present disclosure.

FIG. 5 is a graph illustrating, together with a comparative example, a time from a start of warm-up operation to an end of the warm-up operation of the fuser device according to Embodiment 1 of the present disclosure.

FIGS. 6(a) and 6(b) are schematic diagrams illustrating, together with a comparative example, a stay of a fuser device according to Embodiment 2 of the present disclosure.

FIG. 7 is a graph illustrating, together with a comparative example, a time from a start of warm-up operation to an end of the warm-up operation of the fuser device according to Embodiment 2 of the present disclosure.

### DESCRIPTION OF THE EMBODIMENTS

Hereinafter, embodiments will be described in detail with reference to the drawings.

### Embodiment 1

### Configuration of Image Forming Apparatus

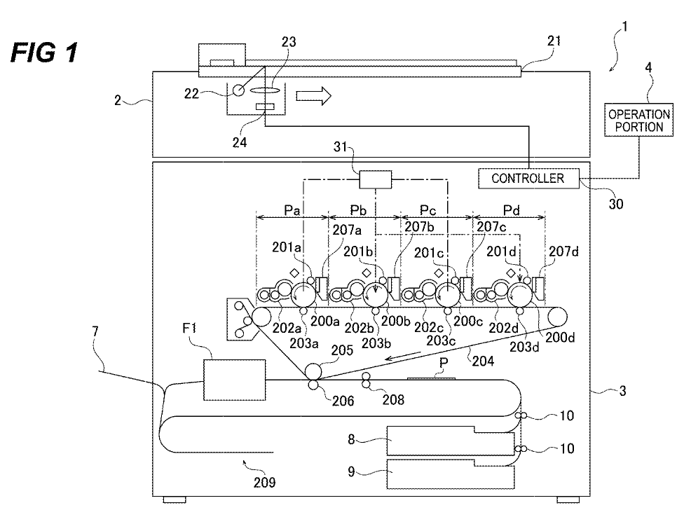

A configuration of an image forming apparatus 1 according to Embodiment 1 of the present disclosure will be described in detail with reference to FIG. 1.

Here, the image forming apparatus 1 is exemplified as a full-color image forming apparatus. The image forming apparatus 1 includes an image reading portion 2 and an apparatus main body 3.

The image reading portion 2 reads an image of an original and outputs an image signal of the read image to a controller 30, which will be described below, of the apparatus main body 3. The image reading portion 2 includes an original base plate glass 21, a light source 22, an optical system member 23, and a CCD sensor 24. The light source 22, the optical system member 23, and the CCD sensor 24 constitute an optical system unit that scans the original in a direction of an arrow in FIG. 1.

The original is placed on the original base plate glass 21.

The light source 22 irradiates the original placed on the original base plate glass 21 with light.

The optical system member 23 is a lens or the like that forms an image on the CCD sensor 24 with reflected light that is reflected from the original after having been irradiated from the light source 22 to the original.

The CCD sensor 24 outputs an image signal of an electric signal data string for each line to the controller 30 of the apparatus main body 3, the image signal being obtained by capturing an image formed by the optical system member 23.

The apparatus main body 3 conveys a recording medium P and accommodates various members configured to form an image on the recording medium P.

### Configuration of Apparatus Main Body

A configuration of the apparatus main body 3 of the image forming apparatus 1 according to Embodiment 1 of the present disclosure will be described in detail with reference to FIG. 1.

The apparatus main body 3 includes image forming portions Pa, Pb, Pc, and Pd, an operation portion 4, a sheet discharge tray 7, a sheet feeding cassette 8, a sheet feeding cassette 9, a feeding roller 10, a controller 30, and a polygon scanner 31. In addition, the apparatus main body 3 includes an intermediate transfer belt 204, a secondary transfer roller 205, a secondary transfer roller 206, a registration portion 208, a reversing portion 209, and a fuser device F1.

The image forming portions Pa, Pb, Pc, and Pd perform image forming processing of forming a toner image by the control of the controller 30. The image forming portion Pa forms a yellow (Y) image. The image forming portion Pb forms a magenta (M) image. The image forming portion Pc forms a cyan (C) image. The image forming portion Pd forms a black (Bk) image.

The image forming portions Pa, Pb, Pc, and Pd include photoconductive drums 200a, 200b, 200c, and 200d and primary chargers 201a, 201b, 201c, and 201d. In addition, the image forming portions Pa, Pb, Pc, and Pd include development devices 202a, 202b, 202c, and 202d, transfer rollers 203a, 203b, 203c, and 203d, and cleaners 207a, 207b, 207c, and 207d.

The photoconductive drums 200a, 200b, 200c, and 200d are rotatably supported by the apparatus main body 3. The photoconductive drums 200a, 200b, 200c, and 200d are uniformly charged by the primary chargers 201a, 201b, 201c, and 201d. After being charged by the primary chargers 201a, 201b, 201c, and 201d, the photoconductive drums 200a, 200b, 200c, and 200d are irradiated with a laser beam and are scanned by the polygon scanner 31, whereby electrostatic latent images are formed on the drums. The electrostatic latent images formed by the polygon scanner 31 are developed by the development devices 202a, 202b, 202c, and 202d, thereby forming toner images on the photoconductive drums 200a, 200b, 200c, and 200d.

The primary chargers 201a, 201b, 201c, and 201d charge front surfaces of the photoconductive drums 200a, 200b, 200c, and 200d at a predetermined potential, thereby preparing the photoconductive drums 200a, 200b, 200c, and 200d to form the electrostatic latent images.

The development devices 202a, 202b, 202c, and 202d develop the electrostatic latent images formed on the photoconductive drums 200a, 200b, 200c, and 200d by the polygon scanner 31. The development devices 202a, 202b, 202c, and 202d form toner images on the photoconductive drums 200a, 200b, 200c, and 200d by developing the electrostatic latent images.

The transfer rollers 203a, 203b, 203c, and 203d are provided on a rear surface of the intermediate transfer belt 204. The transfer rollers 203a, 203b, 203c, and 203d discharge electricity and apply a primary transfer bias having an opposite-polarity to the toner, thereby transferring the toner images on the photoconductive drums 200a, 200b, 200c, and 200d to the intermediate transfer belt 204.

The cleaners 207a, 207b, 207c, and 207d clean the front surfaces of the photoconductive drums 200a, 200b, 200c, and 200d after the toner images are transferred by the transfer rollers 203a, 203b, 203c, and 203d.

The operation portion 4 receives an input of various settings or an operation instruction from a user and outputs, to the controller 30, an electric signal in response to the received input or the operation instruction.

The recording medium P conveyed and discharged by the fuser device F1 is stacked on the sheet discharge tray 7.

The sheet feeding cassette 8 and the sheet feeding cassette 9 accommodate the recording medium P.

The feeding roller 10 feeds the recording medium P accommodated in the sheet feeding cassette 8 or the sheet feeding cassette 9 to the registration portion 208.

The controller 30 controls entire operation of the image forming apparatus 1 based on the electric signal input from the operation portion 4. The controller 30 converts an image signal input from the CCD sensor 24 or a host device such as an external print server (not illustrated) into a pulse width modulation (PWM) signal by PWM control and outputs the converted PWM signal to the polygon scanner 31. The controller 30 performs warm-up operation of heating the fuser device F1 to a target temperature and performs temperature adjustment control of maintaining the fuser device F1 at a predetermined target temperature, based on electric signals input from a transfer target detection portion 95, a thermistor Th1, and a thermistor Th3, which will be described below, of the fuser device F1.

The polygon scanner 31 irradiates and scans the photoconductive drums 200a, 200b, 200c, and 200d charged by the primary chargers 201a, 201b, 201c, and 201d with a laser beam, based on the PWM signal input from the controller 30. The polygon scanner 31 irradiates and scans the photoconductive drums 200a, 200b, 200c, and 200d with the laser beam, thereby forming the electrostatic latent images on the photoconductive drums 200a, 200b, 200c, and 200d.

The toner images formed on the photoconductive drums 200a, 200b, 200c, and 200d are sequentially transferred to the intermediate transfer belt 204 by the transfer rollers 203a, 203b, 203c, and 203d, whereby toner images of four colors are formed on the intermediate transfer belt 204. The intermediate transfer belt 204 conveys, to the secondary transfer roller 205 and the secondary transfer roller 206, the toner images sequentially transferred from the photoconductive drums 200a, 200b, 200c, and 200d by the transfer rollers 203a, 203b, 203c, and 203d.

A secondary transfer electric field having an opposite-polarity to the toner image conveyed by the intermediate transfer belt 204 is applied to the secondary transfer roller 205 and the secondary transfer roller 206 as the transfer portions. The secondary transfer electric field is applied, whereby the secondary transfer roller 205 and the secondary transfer roller 206 secondarily transfer, to the recording medium P conveyed by the registration portion 208, the toner images conveyed by the intermediate transfer belt 204. The secondary transfer roller 205 and the secondary transfer roller 206 convey, to the fuser device F1, the recording medium P to which the toner images have been secondarily transferred.

The registration portion 208 causes the recording medium P fed by the feeding roller 10 to be temporarily put on standby. The registration portion 208 conveys the recording medium P put on standby to the secondary transfer roller 205 and the secondary transfer roller 206 at a timing when the toner images on the intermediate transfer belt 204 and the position of the recording medium P are matched.

In the case of a double-sided job, the reversing portion 209 reverses front and back of the recording medium P on which the toner image has been fixed with respect to a first surface conveyed by the fuser device F1 and conveys the reversed recording medium P to the registration portion 208.

The fuser device F1 maintains the target temperature by the control of the controller 30 after performing heating until a fuser nip portion N reaches a predetermined target temperature. The fuser device F1 heats and pressurizes the toner images secondarily transferred to the recording medium P conveyed by the secondary transfer roller 205 and the secondary transfer roller 206, thereby fixing the toner image to the recording medium P. The fuser device F1 discharges, to the sheet discharge tray 7, the recording medium P to which the toner image has been fixed or conveys the recording medium P to the reversing portion 209.

### Configuration of Fuser Device

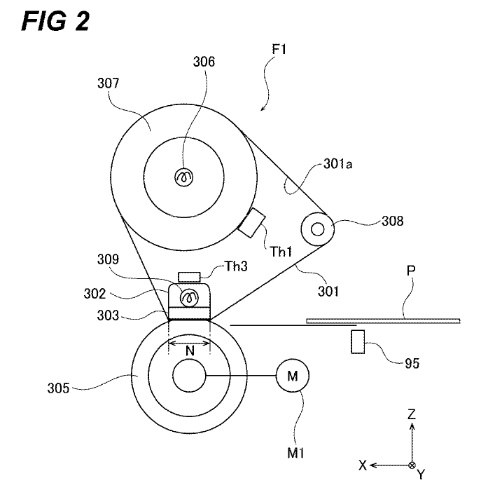

A configuration of the fuser device F1 according to Embodiment 1 of the present disclosure will be described in detail with reference to FIG. 2.

Note that, in FIG. 2, an X direction is a conveyance direction of the recording medium P, a Y direction is a width direction orthogonal to the X direction and a Z direction, and the Z direction is a pressurizing direction orthogonal to the X direction and the Y direction.

The fuser device F1 includes the transfer target detection portion 95, a fuser belt 301, a stay 302, a pressure pad 303, a pressure roller 305, a heating halogen heater 306, and a heating roller 307. In addition, the fuser device F1 includes a steering roller 308, a stay halogen heater 309, the thermistor Th1, and the thermistor Th3.

The transfer target detection portion 95 detects a timing when the recording medium P enters the fuser device F1, and outputs an electric signal corresponding to the detection result to the controller 30.

The fuser belt 301 as a belt has a thin cylindrical shape and an endless shape and is rotatable. The fuser belt 301 has thermal conductivity, heat resistance, and the like. The fuser belt 301 has a three-layer structure in which a base layer, an elastic layer provided on an outer circumferential surface of the base layer, and a toner parting layer provided on an outer circumferential surface of the elastic layer are laminated. The base layer has a thickness of 80 µm and is made of a polyimide resin (PI). The elastic layer has a thickness of 300 µm and is made of silicone rubber. The toner parting layer has a thickness of 30 µm and is made of a tetrafluoroethylene-perfluoroalkoxyethylene copolymer resin (PFA) as a fluororesin.

The fuser belt 301 is tensioned by the pressure pad 303, the heating roller 307, and the steering roller 308. Lubricant is applied to an inner circumferential surface of the fuser belt 301 so that the fuser belt 301 smoothly slides with respect to a sliding member which will be described below. Here, silicone oil is exemplified as the lubricant. The fuser belt 301 is tensioned by the stay 302, the heating roller 307, and the steering roller 308.

The stay 302 as a support member is located inside the fuser belt 301 and tensions the fuser belt 301. The stay 302 supports the pressure pad 303. The stay 302 is hollow inside, and a cross section taken along a plane orthogonal to the width direction has a quadrangular shape. The stay 302 has a thickness of 3 mm and is made of stainless steel. Note that the stay 302 is not limited to the case of being made of stainless steel, and may be made of a metal other than stainless steel, such as iron or aluminum, or may be made of a resin. In addition, details of the configuration of the stay 302 will be described below.

The pressure pad 303 as a nip formation member is made of a liquid crystal polymer (LCP). Note that the pressure pad 303 is not limited to the case of being made of the LCP, and may be made of a resin or a metal other than the LCP. The pressure pad 303 faces the pressure roller 305 via the fuser belt 301 and abuts the fuser belt 301 such that the fuser nip portion N is formed. A sliding member (not illustrated) is interposed between the pressure pad 303 and the fuser belt 301, and the pressure pad is pressed by the pressure roller 305 with the sliding member and the fuser belt 301 interposed therebetween. When the pressure pad 303 is pressed by the pressure roller 305, a load is applied in a direction of the pressure roller 305 (a direction opposite to the Z direction) by the stay 302.

The pressure roller 305 as a pressure member faces and abuts the fuser belt 301 and nips and conveys, together with the fuser belt 301, the recording medium P in the fuser nip portion N.

The pressure roller 305 is a roller formed by laminating a core metal layer, an elastic layer provided on an outer circumferential surface of the core metal layer, and a toner parting layer provided on an outer circumferential surface of the elastic layer. The core metal layer has a diameter of 72 mm and is made of SUS. The elastic layer has a thickness of 8 mm and is made of conductive silicone rubber. The toner parting layer has a thickness of 100 µm and is made of a tetrafluoroethylene-perfluoroalkoxyethylene copolymer resin (PFA) as a fluororesin.

The pressure roller 305 is rotatably shaft-supported by a fuser frame (not illustrated) of the fuser device F1 and is connected to a drive source M1 via a gear (not illustrated) secured to one end portion thereof in the width direction. The pressure roller 305 is rotationally driven by performing driving of the drive source M1.

The pressure roller 305 is driven by a drive source (not illustrated) to pressurize the pressure pad 303 via the fuser belt 301.

The heating halogen heater 306 is provided inside the heating roller 307. The heating halogen heater 306 heats the heating roller 307 when energized by the control of the controller 30.

The heating roller 307 as a heating member is located inside the fuser belt 301 and tensions the fuser belt 301. The heating roller 307 is a pipe that has a thickness of 2 mm and is made of aluminum. Note that the heating roller 307 is not limited to the case of being made of aluminum, and may be made of a metal other than aluminum, such as stainless steel, and is desirably made of a material having a high heat conduction in consideration of a temperature increase at an end portion in the width direction at the time of sheet passing.

The heating roller 307 heats the fuser belt 301 by being heated by the heating halogen heater 306. An inner surface of the heating roller 307 is coated in black to efficiently absorb thermal energy from the heating halogen heater 306. Note that the inner surface of the heating roller 307 is not limited to the configuration in which the inner surface is coated in black, and may be configured to be subjected to black plating processing or the like in order to increase an absorption ratio of thermal energy. The heating roller 307 is connected to the drive source M1 via a gear (not illustrated) secured to one end portion thereof in the width direction. The heating roller 307 is rotationally driven by performing driving of the drive source M1.

The steering roller 308 as a tension member is located inside the fuser belt 301 and tensions the fuser belt 301. The steering roller 308 is hollow, has a diameter ? of 20 mm, and is made of SUS. The steering roller 308 has a rotation center between one end portion in the width direction and the vicinity of a central portion and rotates with respect to the fuser belt 301, thereby generating a tension difference between one end portion side and the other end portion side in the width direction to control a position of the fuser belt 301 in the width direction. Note that a rubber material or the like may be provided on a front surface of the steering roller 308 in order to improve the grip strength with respect to the fuser belt 301.

The stay halogen heater 309 as a heater is provided inside the hollow stay 302. The stay halogen heater 309 heats the stay 302 when energized by the control of the controller 30.

The thermistor Th1 is provided in the state of abutting the heating roller 307. The thermistor Th1 is provided at a central portion of the recording medium P in the width direction. The thermistor Th1 detects a temperature of the heating roller 307 and outputs an electric signal corresponding to the detected temperature to the controller 30.

The thermistor Th3 is provided in the state of abutting the stay 302. The thermistor Th3 is provided at a central portion of the recording medium P in the width direction. The thermistor Th3 detects a temperature of the stay 302 and outputs an electric signal corresponding to the detected temperature to the controller 30.

In the fuser device F1 having the configuration described above, the recording medium P carrying the toner image is heated while being nipped and conveyed in the fuser nip portion N formed between the fuser belt 301 and the pressure roller 305. Consequently, the toner image is fixed to the recording medium P. As described above, the fuser nip portion N is desirable to have both a function of applying heat and pressure and a function of conveying the recording medium P. The pressure force (NF) at the time of printing in the fuser nip portion N is 1600 N, a width of the fuser nip portion N in the conveyance direction is 24.5 mm, and a width of the fuser nip portion N in the width direction is 326 mm.

In addition, a sheet discharge unit (not illustrated) that discharges the recording medium P having passed through the fuser nip portion N to the outside of the fuser device F1 is provided downstream from the fuser nip portion N in the conveyance direction. The sheet discharge unit includes a separation unit (not illustrated) that releases a sheet from the fuser belt 301.

Further, the fuser device F1 includes a thermistor (not illustrated) at a position which is separated from a central portion of the recording medium P in the width direction by 150 mm in the width direction in order to control a temperature distribution of the recording medium P in the width direction in the heating roller 307. Note that a position at which the thermistor is provided is not limited to the position which is separated from the central portion of the recording medium P in the width direction by 150 mm in the width direction, and may be changed according to a size of the recording medium P to be passed. In addition, the number of thermistors provided to control the temperature distribution of the recording medium P in the width direction in the heating roller 307 is not limited to one, and a plurality of thermistors may be used.

Note that the fuser device F1 may include a halogen heater inside the steering roller 308. In addition, the fuser device F1 may include a thermistor at an end portion of the stay 302 in the width direction in order to control the temperature distribution of the recording medium P in the width direction in the stay 302.

### Configuration of Stay

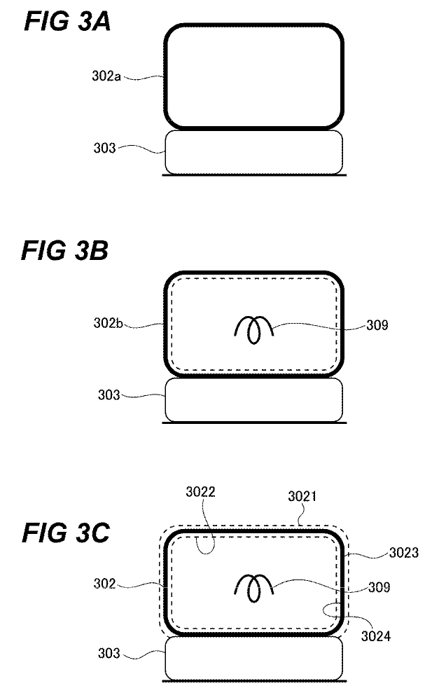

The configuration of the stay 302 of the fuser device F1 according to Embodiment 1 of the present disclosure will be described in detail with reference to FIGS. 2 and 3(c). FIG. 3(c) is a schematic view illustrating the configuration of the stay 302 of the fuser device F1 according to the embodiment.

An outer surface portion 3023 of the stay 302 is provided with a first heat absorption portion 3021 facing an inner circumferential surface 301a of the fuser belt 301 by being subjected to processing for efficiently absorbing thermal energy. In addition, an inner surface portion 3024 of the stay 302 is provided with a second heat absorption portion 3022 facing the stay halogen heater 309 by being subjected to the processing for efficiently absorbing thermal energy. The second heat absorption portion 3022 is provided to efficiently absorb thermal energy from the stay halogen heater 309. In addition, the first heat absorption portion 3021 is provided to efficiently absorb radiant heat radiating from the fuser belt 301, the heating roller 307, and the steering roller 308.

Specifically, the first heat absorption portion 3021 and the second heat absorption portion 3022 desirably have a total emissivity of 40% or more at 200° C., and are, for example, black galvanized layers formed by performing black plating processing. A total emissivity of a black galvanized surface is 65%. A thickness of the black galvanized layer is desirably about 3 to 6 µm, and here, a thickness of 5 µm is exemplified.

Note that the thickness of the black galvanized layer is not limited to about 3 to 6 µm and may be smaller than 3 µm or larger than 6 µm. In addition, the first heat absorption portion 3021 and the second heat absorption portion 3022 are not limited to the black galvanized layer, and may be formed by applying a black coating material, or may be a black coated layer obtained by being subjected to processing other than the black galvanizing. In addition, a method of measuring the total emissivity will be described below.

In the stay 302 having the configuration described above, the black galvanized layer is formed by electrogalvanizing processing in which zinc is attached on a front surface of a metal by using an electrical method. At this time, zinc is attached to the outer surface portion 3023 and the inner surface portion 3024 of the stay 302 by causing a current to flow using an electrolyte containing zinc, with the stay 302 as an anode. In addition, the black color of the black galvanized layer can be produced to have a blackish hue by using cobalt.

Note that the black galvanized layer is not limited to the case of being formed by the electrogalvanizing processing and may be formed by a manufacturing process in which another plating processing such as hot-dip galvanizing processing is performed. In addition, the black color of the black galvanized layer is not limited to the case of being produced to have a blackish hue by using cobalt and may be produced using an oxide of silver or the like other than cobalt.

### Warm-up Operation of Fuser Device

The warm-up operation of the fuser device F1 according to Embodiment 1 of the present disclosure will be described in detail with reference to FIGS. 2 to 5.

The warm-up operation of the fuser device F1 is started when a main body power supply (not illustrated) of the image forming apparatus 1 is turned on.

First, the drive source M1 starts rotating at a low speed of 30 mm/sec under the control of the controller 30. Consequently, the heating roller 307 starts rotating. In addition, the fuser belt 301 and the steering roller 308 also start rotating by being driven by the rotation of the heating roller 307. At this time, the fuser belt 301 rotates while sliding with respect to the secured pressure pad 303.

Next, the heating halogen heater 306 heats the fuser belt 301 by being supplied with electric power from the power supply (not illustrated) under the control of the controller 30. Consequently, the heating roller 307 absorbs thermal energy from the heating halogen heater 306 and starts increasing the temperature. In addition, the stay halogen heater 309 heats the stay 302 by being supplied with electric power from the power supply (not illustrated) under the control of the controller 30. Consequently, the stay 302 absorbs thermal energy from the stay halogen heater 309 and starts increasing the temperature.

At this time, since the electric power obtained from an electrical outlet is restricted, the electric power is distributed to the heating halogen heater 306 and the stay halogen heater 309 within the restriction. In the embodiment, the electric power supplied to the heating halogen heater 306 is 1800 W, and the electric power supplied to the stay halogen heater 309 is 200 W.

Here, in a case where the pressure pad 303 is made of a resin having a low heat conductivity, the thermal energy from the stay halogen heater 309 is unlikely to be transferred to the fuser belt 301. Hence, in this case, when sheet passing is started, a large amount of electric power is distributed to the heating halogen heater 306 so that thermal energy can be more efficiently applied to the recording medium P. On the other hand, in a case where the pressure pad 303 is made of a metal having a high heat conductivity, an electric power distribution ratio to the stay halogen heater 309 may be increased as compared with the case where the pressure pad 303 is made of a resin. In addition, in the case of a configuration in which the stay halogen heater 309 is not provided, electric power of 2000 W may be distributed to the heating halogen heater 306.

The heating halogen heater 306 continues heating by being supplied with electric power of 1800 W until a temperature detected by the thermistor Th1 reaches a target temperature of 160° C. Then, temperature adjustment of the heating halogen heater 306 is controlled by the controller 30 so that the temperature detected by the thermistor Th1 maintains constant after reaching the target temperature. Similarly, the stay halogen heater 309 continues heating by being supplied with electric power of 200 W until a temperature detected by the thermistor Th3 reaches the target temperature of 160° C. Then, temperature adjustment of the stay halogen heater 309 is controlled by the controller 30 so that the temperature detected by the thermistor Th3 maintains constant after reaching the target temperature.

When the temperatures detected by the thermistor Th1 and the thermistor Th3 reach the target temperature, the warm-up operation of the fuser device F1 is ended.

As described above, the electric power distributed to the stay halogen heater 309 is smaller than the electric power distributed to the heating halogen heater 306. Accordingly, a time taken for the temperature detected by the thermistor Th3 to reach the target temperature is longer than a time taken for the temperature detected by the thermistor Th1 to reach the target temperature. In a case where printing operation is started in a state in which the temperature detected by the thermistor Th3 has not reached the target temperature, the temperature of the fuser belt 301 is significantly decreased, and the toner fixability and the density stability are lost. Hence, a time point when the temperature detected by the thermistor Th3 reaches the target temperature is set as the end of the warm-up operation of the fuser device F1.

Subsequently, a temperature change from the start of the warm-up operation to the end of the warm-up operation of the fuser device F1 according to the embodiment will be described in comparison with comparative examples.

In FIG. 3, FIG. 3(a) illustrates a stay 302a of Comparative Example 1 which does not have the stay halogen heater 309 and in which the black galvanizing is not performed to both an inner surface portion and an outer surface portion of the stay. In addition, FIG. 3(b) illustrates a stay 302b of Comparative Example 2 which has the stay halogen heater 309 and in which the black galvanizing is performed only on an inner surface portion of the stay. FIG. 3(c) illustrates the stay 302 of the embodiment which has the stay halogen heater 309 and includes the black galvanized first heat absorption portion 3021 and the black galvanized second heat absorption portion 3022.

In addition, a total emissivity of a surface subjected to the black galvanizing is 65%, and a total emissivity of a stainless steel surface which is not subjected to the black galvanizing is 15%. Note that, in Comparative Example 1, since the stay halogen heater 309 is not provided, electric power of 2000 W is supplied to the heating halogen heater 306.

Here, FTIR (System 2000 type manufactured by Perkin Elmer) was used in measurement of the total emissivity. In addition, as measurement conditions, a measurement region is 370 to 7800 cm⁻¹, a cumulated number is 200 times, a light source is MIR, a detector is MIR-TGS, and resolution is 16 cm⁻¹. Further, an optical path from the light source to the detector was filled with N2 gas and purged. Then, a total emissivity at 200° C was calculated from data obtained by measuring a reflection spectrum at room temperature (according to JIS R 1693-2: 2012).

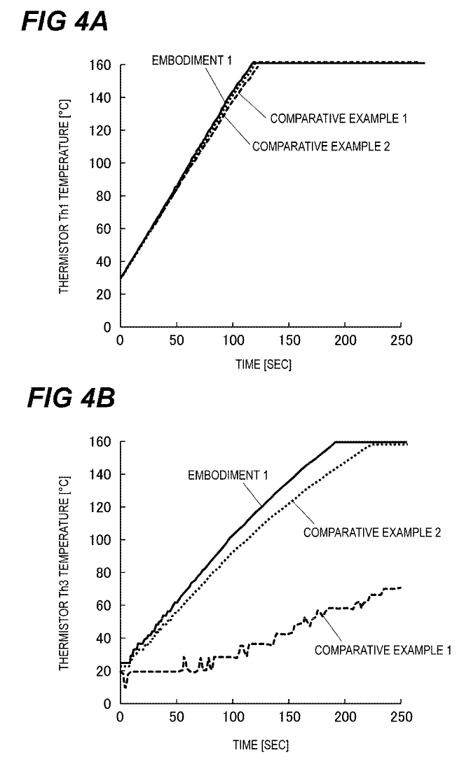

In FIG. 4, FIG. 4(a) illustrates a temperature change from the start of the warm-up operation to the end of the warm-up operation of the thermistor Th1 in Comparative Example 1, Comparative Example 2, and the embodiment. FIG. 4(b) illustrates a temperature change from the start of the warm-up operation to the end of the warm-up operation of the thermistor Th3 in Comparative Example 1, Comparative Example 2, and the embodiment. Note that, in FIG. 4(b), the temperature change of Comparative Example 1 is the temperature change from the start of the warm-up operation to a time point earlier than the end of the warm-up operation of the thermistor Th3.

As is clear from FIG. 4(b), it can be found that the stay 302a of Comparative Example 1 has a very gentle temperature increase curve, and a long time is taken to reach the target temperature of 160° C. In addition, the stay 302 of the embodiment has a steeper temperature increase curve than the stay 302b of Comparative Example 2, and a time taken to reach the target temperature of 160° C. is shorter than that of Comparative Example 2. As described above, the stay 302 of the embodiment can efficiently absorb radiant heat from the fuser belt 301, the heating roller 307, and the steering roller 308.

Next, from FIG. 4(a), the stay 302b of Comparative Example 2 having the stay halogen heater 309 and the stay 302 of the embodiment have respective steeper temperature increase curves than the stay 302a of Comparative Example 1 without including the stay halogen heater 309. This is because the stay 302b and the stay 302 having the heat source are efficiently heated by the heat source, thereby enabling flow of heat conduction flowing from the heating roller 307 via the fuser belt 301 to the stay 302 or the stay 302b to be curbed. In addition, in the stay 302 of the embodiment, a slightly shorter time is taken to reach the target temperature than the stay 302b of Comparative Example 2 due to the same reason as described above.

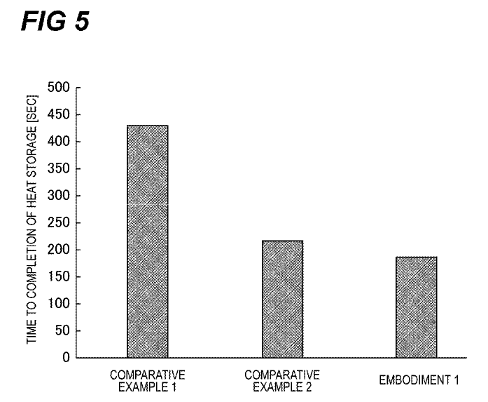

FIG. 5 illustrates comparison of times taken from the start of the warm-up operation to the end of the warm-up operation at which the thermistors Th1 and Th3 have reached the target temperature (times to the completion of heat storage) between Comparative Example 1, Comparative Example 2, and the embodiment.

As can be found from FIG. 5, in Comparative Example 2 and the embodiment having the stay halogen heater 309, the time taken from the start of the warm-up operation to the end of the warm-up operation is shorter than that in Comparative Example 1. In addition, it can be found that, in the stay 302 of the embodiment, a time taken from the start of the warm-up operation to the end of the warm-up operation is shorter than that in the stay 302b of Comparative Example 2. Accordingly, the stay 302 of the embodiment absorbs the thermal energy by the first heat absorption portion 3021 in addition to the second heat absorption portion 3022, so that the warm-up operation can be ended more quickly.

According to the embodiment, the stay 302 includes the first heat absorption portion 3021 having a total emissivity equal to or larger than a predetermined value on the surface facing the inner circumferential surface 301a of the fuser belt 301, thereby enabling the faster warm-up operation to be realized.

Note that, in the embodiment, the stay 302 is provided with the first heat absorption portion 3021 and the second heat absorption portion 3022. However, the invention is not limited thereto, and a heat absorption portion similar to the first heat absorption portion 3021 may be provided on an outer surface portion of the steering roller 308, in addition to the stay 302 or instead of the stay 302.

In addition, in the embodiment, the second heat absorption portion 3022 is provided on the inner surface portion 3024 of the stay 302, but the present disclosure is not limited thereto, and the second heat absorption portion 3022 does not need to be provided as long as the first heat absorption portion 3021 can sufficiently apply thermal energy to the recording medium P.

### Embodiment 2

Since a configuration of an image forming apparatus according to Embodiment 2 of the present disclosure is the same as that in FIG. 1, the description thereof will be omitted.

### Configuration of Fuser Device

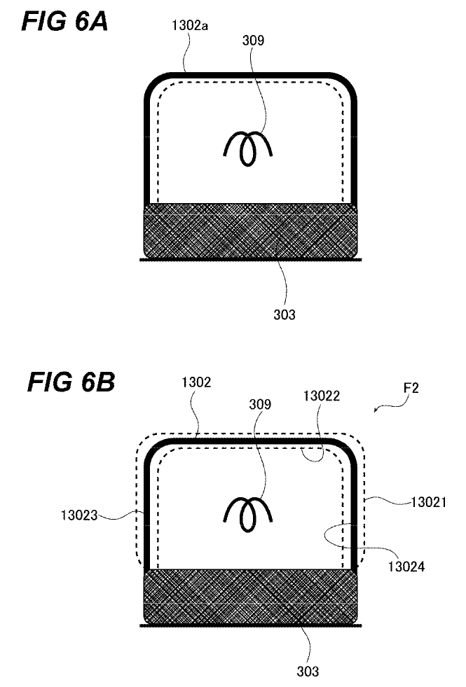

A configuration of a fuser device F2 according to Embodiment 2 of the present disclosure will be described in detail with reference to FIG. 6(b).

FIG. 6(b) is a schematic diagram illustrating a configuration of a stay 1302 of the fuser device F2 according to the embodiment.

Note that, in FIG. 6(b), parts having the same configuration as those in FIG. 3 are denoted by the same reference numerals, and the descriptions thereof will be omitted.

The fuser device F2 includes the transfer target detection portion 95, the fuser belt 301, the pressure pad 303, the pressure roller 305, the heating halogen heater 306, the heating roller 307, and the steering roller 308. In addition, the fuser device F2 includes the stay halogen heater 309, the stay 1302, the thermistor Th1, and the thermistor Th3. Note that since configurations of the fuser device F2 except for the stay 1302 are the same as the configurations of the fuser device F1, illustration thereof is omitted.

The stay 1302 supports the pressure pad 303. The stay 1302 has a shape in which a side inside the hollow stay 1302 is open to the outside, the side facing the pressure pad 303, and a cross section taken along a plane orthogonal to the width direction has a U-shape. The stay 1302 has a thickness of 3 mm and is made of stainless steel. Note that the stay 1302 is not limited to the case of being made of stainless steel, and may be made of a metal other than stainless steel, such as iron or aluminum, or may be made of a resin.

The stay halogen heater 309 is provided inside the stay 1302.

The thermistor Th3 is provided in the state of abutting the stay 1302. The thermistor Th3 is provided at a central portion of the recording medium P in the width direction. The thermistor Th3 detects a temperature of the stay 1302 and outputs an electric signal corresponding to the detected temperature to the controller 30.

In the fuser device F2 having the configuration described above, the pressure force (NF) at the time of printing in the fuser nip portion N is 800 N. In a case where the image gloss on a printed product may be allowed to be low, the pressure force at the time of printing in the fuser nip portion N can be reduced to a light load. In a case where the pressure force at the time of printing in the fuser nip portion N is the light load, the amount of deflection of the stay 1302 in the width direction can be made equal to the amount of deflection of the stay 302 in the width direction even if the second moment of area of the stay 1302 is made smaller than the second moment of area of the stay 302. Hence, the stay 1302 can have the above-described shape different from that of the stay 302.

### Configuration of Stay

A configuration of the stay 1302 of the fuser device F2 according to Embodiment 2 of the present disclosure will be described in detail with reference to FIG. 6(b).

An outer surface portion 13023 of the stay 1302 is provided with a first heat absorption portion 13021 facing an inner circumferential surface of the fuser belt 301 by being subjected to the processing for efficiently absorbing thermal energy. In addition, an inner surface portion 13024 of the stay 1302 is provided with a second heat absorption portion 13022 facing the stay halogen heater 309 by being subjected to the processing for efficiently absorbing thermal energy. The second heat absorption portion 13022 is provided to efficiently absorb thermal energy from the stay halogen heater 309. In addition, the first heat absorption portion 13021 is provided to efficiently absorb radiant heat radiating from the fuser belt 301, the heating roller 307, and the steering roller 308.

Specifically, the first heat absorption portion 13021 and the second heat absorption portion 13022 desirably have a total emissivity of 40% or more at 200° C., and are, for example, black galvanized layers formed by plating processing. A total emissivity of a surface subjected to the black galvanizing is 65%. A thickness of the black galvanized layer is desirably about 3 to 6 µm, and here, a thickness of 5 µm is exemplified. Note that the thickness of the black galvanized layer is not limited to about 3 to 6 µm and may be smaller than 3 µm or larger than 6 µm. In addition, the first heat absorption portion 13021 and the second heat absorption portion 13022 are not limited to the black galvanized layer, and may be formed by applying a black coating material, or may be a black coated layer obtained by being subjected to processing other than the black galvanizing.

In the stay 1302 having the configuration described above, the black galvanized layer is formed by electrogalvanizing processing in which zinc is attached on a front surface of a metal by using an electrical method. At this time, zinc is attached to the outer surface portion 13023 and the inner surface portion 13024 of the stay 1302 by causing a current to flow using an electrolyte containing zinc, with the stay 1302 as an anode. In addition, the black color of the black galvanized layer can be produced to have a blackish hue by using cobalt.

Note that the black galvanized layer is not limited to the case of being formed by the electrogalvanizing processing and may be formed by a manufacturing process in which another plating processing such as hot-dip galvanizing processing is performed. In addition, the black color of the black galvanized layer is not limited to the case of using cobalt and may use an oxide of silver or the like other than cobalt.

### Warm-up Operation of Fuser Device

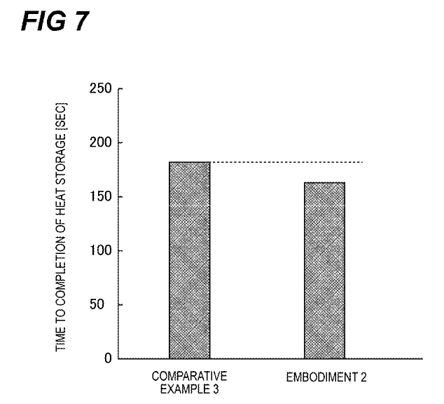

The warm-up operation of the fuser device F2 according to Embodiment 2 of the present disclosure will be described in detail with reference to FIGS. 6 to 7.

A temperature change from the start of the warm-up operation to the end of the warm-up operation of the fuser device F2 according to the embodiment will be described in comparison with comparative examples.

In FIG. 6, FIG. 6(a) illustrates a stay 1302a of Comparative Example 3 which has the stay halogen heater 309 and in which the black galvanizing is performed only on an inner surface portion of the stay. FIG. 6(b) illustrates the stay 1302 of the embodiment which has the stay halogen heater 309 and includes the black galvanized first heat absorption portion 13021 and the black galvanized second heat absorption portion 13022. In addition, a total emissivity of a surface subjected to the black galvanizing is 65%, and a total emissivity of a stainless steel surface which is not subjected to the black galvanizing is 15%. Note that the total emissivity was measured in the same manner as in Embodiment 1.

FIG. 7 illustrates comparison between times taken from the start of the warm-up operation to the end of the warm-up operation at which the thermistors Th1 and Th3 have reached the target temperature between Comparative Example 3 and the embodiment.

It can be found from FIG. 7 that, in the stay 1302 of the embodiment, a time taken from the start of the warm-up operation to the end of the warm-up operation is shorter than that in the stay 1302a of Comparative Example 3. Accordingly, the stay 1302 of the embodiment absorbs the thermal energy by the first heat absorption portion 13021 in addition to the second heat absorption portion 13022, so that the warm-up operation can be ended more quickly. In addition, the stay 1302 configured to have a U-shape having a smaller heat capacity than that of the stay 302 obtained a result in which the warm-up operation was ended in a shorter time compared with the stay 302.

Note that, warm-up operation other than the warm-up operation described above in the warm-up operation of the fuser device F2 is the same as the warm-up operation of the fuser device F1, and thus the description thereof will be omitted.

According to the embodiment, the stay 1302 includes the first heat absorption portion 13021 having a total emissivity equal to or larger than a predetermined value on the surface facing the inner circumferential surface 301a of the fuser belt 301, thereby enabling the faster warm-up operation to be realized.

Note that, in the embodiment, the stay 1302 is provided with the first heat absorption portion 13021 and the second heat absorption portion 13022. However, the invention is not limited thereto, and a heat absorption portion similar to the first heat absorption portion 13021 may be provided on an outer surface portion of the steering roller 308, in addition to the stay 1302 or instead of the stay 1302.

In addition, in the embodiment, the second heat absorption portion 13022 is provided on the inner surface portion 13024 of the stay 1302, but the present disclosure is not limited thereto, and the second heat absorption portion 13022 does not need to be provided as long as the first heat absorption portion 13021 can sufficiently apply thermal energy to the recording medium P.

It goes without saying that the present disclosure is not limited to the embodiments described above, and various modifications can be made within a range without departing from the gist of the present disclosure.

Specifically, although the steering roller 308 is provided in Embodiment 1 and Embodiment 2 described above, the present disclosure is not limited thereto, and the steering roller 308 does not need to be provided as long as the fuser belt 301 can be tensioned by the stay 302 and the heating roller 307.

According to the present disclosure, faster warm-up operation can be realized.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No.2025-73135, filed Apr. 25, 2025, which is hereby incorporated by reference herein in its entirety.

What is claimed is:

1. A fuser device configured to fix, to a recording medium, a toner image on the recording medium, the fuser device comprising:
a rotatable endless belt;
a heating member configured to be located inside the belt, to tension the belt, and to heat the belt;
a rotatable pressure member configured to abut the belt to nip and convey, together with the belt, a recording medium;
a nip formation member configured to face the pressure member via the belt and to abut the belt to form a fuser nip portion; and
a support member configured to support the nip formation member,
wherein the support member includes a first heat absorption portion having a total emissivity of 40% or more on a surface facing an inner circumferential surface of the belt.

2. The fuser device according to claim 1, comprising a heater configured to be located inside the hollow support member and heats the support member.

3. The fuser device according to claim 2, wherein the support member includes a second heat absorption portion having a total emissivity of 40% or more on a surface facing the heater.

4. The fuser device according to claim 1, wherein the first heat absorption portion is formed by performing black coating or black plating processing.

5. The fuser device according to claim 1, wherein the first heat absorption portion is a black galvanized layer.

6. A fuser device configured to fix, to a recording medium, a toner image on the recording medium, the fuser device comprising:
a rotatable endless belt;
a heating member configured to be located inside the belt, to tension the belt, and to heat the belt;
a rotatable pressure member configured to abut the belt to nip and convey, together with the belt, a recording medium;
a nip formation member configured to face the pressure member via the belt and to abut the belt to form a fuser nip portion; and
a support member configured to support the nip formation member,
wherein the support member is subjected to black coating or black plating processing on a surface facing an inner circumferential surface of the belt.

7. The fuser device according to claim 6, comprising a heater configured to be located inside the hollow support member and heat the support member.

8. The fuser device according to claim 7, wherein the support member is subjected to the black coating or the black plating processing on a surface facing the heater.

9. An image forming apparatus comprising:
the fuser device according to claim 1;
an image forming portion configured to form a toner image; and
a transfer portion configured to transfer a toner image formed by the image forming portion to a recording medium and convey, to the fuser device, the recording medium to which the toner image has been transferred.

10. An image forming apparatus comprising:
the fuser device according to claim 6;
an image forming portion configured to form a toner image; and
a transfer portion configured to transfer a toner image formed by the image forming portion to a recording medium and convey, to the fuser device, the recording medium to which the toner image has been transferred.
